(19) United States
(12) Patent Application Publication
(10) Pub. No.: US 2024/0141631 A1
(43) Pub. Date: May 2, 2024

(54) Water Outlet Equipment Installed in a Narrow Space, Installation Method and Assembly Method thereof

(71) Applicant: Xiamen Aquasu Electric Shower Co., Ltd., Xiamen (CN)

(72) Inventors: Quanduo HOU, Xiamen (CN); Yan ZENG, Xiamen (CN)

(21) Appl. No.: 18/448,932

(22) Filed: Aug. 12, 2023

(30) Foreign Application Priority Data
Oct. 31, 2022 (CN) 202222906339.0

(51) Int. Cl. E03C 1/02

(52) U.S. Cl. CPC E03C 1/025

(57) ABSTRACT

Provided is a water outlet equipment adapted for a narrow space, an installation and an assembly method thereof. The water outlet equipment is installed within a single-bowl kitchen cabinet, and includes an external case having a base plate; a water pump sited on the base plate; an ice water tank secured above the water pump, an interior of the ice water tank being provided with a soda water tank; a compressor; a boiled water tank secured on the compressor, and is level with the ice water tank; a carbon dioxide cylinder in communication with the soda tank; a waterway plate anchored on the boiled water tank, and the waterway plate is in communication with the water pump, the boiled water tank, the compressor, the ice water tank, and the soda water tank, respectively.

### FIELD OF THE DISCLOSURE

The present disclosure relates a water outlet equipment, especially to a water outlet equipment installed in a narrow space, installation method and assembly method thereof.

### BACKGROUND OF THE DISCLOSURE

For people's domestic water convenience, there are water outlets with different functions installed in the kitchen. Different water tanks and waterway connections are expected according to the needs of users, such as providing clean water, ice water, boiling water, soda water, sparkling water, etc.

Due to the limited installation space in the kitchen, when installing the water outlet, the frequent installation space is the bottom of the cabinet. In view of the needs of young people living alone, most of the available cabinets in the market are designed to have a single-bowl kitchen sink (as shown in FIG. 1). In the case of single-bowl design, the space at the bottom is more limited than others. In some families, part of the space under the sink will be occupied by a trash can or a garbage disposal device, which leads to even smaller installation space. All of these make it difficult for the water outlet to be placed at the bottom of the cabinet, and it is even more difficult for those water outlets available on the market to be installed in the narrow space under the single-bowl kitchen sink.

Due to the limited and narrow installation space at the bottom of the cabinet, and the low location of the cabinet, uses would have to half-bend to achieve the heavy water outlets which have multiple water tanks, metal pipes, electrical components, etc. no matter when putting in or taking out the water outlets for maintenance. However, bending over to move a heavy water outlet may cause injury. Accordingly, large size, complicated installation, and challenging transportation have become unavoidable problems for water outlets suited for single-bowl kitchen sinks.

### SUMMARY OF THE DISCLOSURE

Accordingly, one object of the present disclosure is to provide a water outlet equipment installed in a narrow space, an installation method and an assembly method thereof. The water outlet equipment can be easily transported and installed by the user, and can be used normally after the installation is in place.

The provided water outlet equipment, installation method and assembly method can solve the problems as raised in the background.

The present disclosure is described by following:

The water outlet equipment is installed inside a kitchen cabinet having single-bowl sink. The water outlet equipment includes:
an external case having a base plate;
a water pump sited on the base plate;
an ice water tank secured above the water pump, the ice water tank being connected to a refrigeration system, and an interior of the ice water tank is provided with a soda water tank;
a compressor sited on the same horizontal plane and the same straight line as the water pump;
a boiled water tank secured on the compressor, and is level with the ice water tank;
a carbon dioxide cylinder in communication with the soda tank;
a waterway plate anchored on the a top of the boiled water tank, and the waterway plate is in communication with the water pump, the boiled water tank, the compressor, the ice water tank, and the soda water tank, respectively;
a fitting disposed through the bottom of the kitchen cabinet, the fitting including a secure seat attached to the base plate of the kitchen cabinet, and a secure seat extending upward to provide a locking receiver;
a mounting member anchored under the base plate, the mounting member including a plurality of wheels slidably attached to the bottom of the kitchen cabinet, and a mount seat adapted for the locking receiver.

In some embodiments, the water outlet equipment further includes a filter member. The filter member is connected to the waterway plate through a pipe. The waterway plate includes a water inlet pipe connected to a pressured water, a boiled water outlet pipe in fluid communication with the boiled water tank, a multi-purpose water outlet pipe in fluid communication with the ice water tank and the soda water tank, a pressure water inlet solenoid valve located between the water inlet pipe and the filter member, a boiled water inlet solenoid valve located between the filter member and the boiled water tank, an ice water inlet solenoid valve located between the filter member and the ice water tank, a soda water outlet solenoid valve connected to the soda water tank, an ice water outlet solenoid valve connected to the ice water tank, and a clean water outlet solenoid valve located between the multi-purpose water outlet pipe and the filter member.

In some embodiments, the refrigeration system includes a condenser arranged on the base plate, a condensation pipe connected to the condenser and access to the ice water tank, and a compressor connected to a bottom of the boiled water tank.

In some embodiments, an air intake net is arranged on one side of the external case, an intake fan is located at a position corresponding to the air intake net, and the intake fan is arranged between the air intake net and the condenser.

In some embodiments, the bottom of the air intake fan is in communication with the mount seat and the secure seat in sequence.

In some embodiments, the mount seat includes an air collecting hopper connected to the air intake fan, and a mounting ring secured on the external of the bottom of the air collecting hopper. The mounting ring is hollow, and an outer diameter of the mounting ring is fitted to inner diameter of the locking receiver.

In some embodiments, a UV disinfection device is embedded inside the multi-purpose water outlet pipe. The UV disinfection device includes an isolation shell connected to the multi-purpose water outlet pipe, a UV disinfection component arranged inside the isolation shell, and an inner channel in communication with the waterway plate and located within the isolation shell.

In some embodiments, a gasket is secured to one side of the bottom of the mounting member away from the two wheels.

The present disclosure further provides a method for installing the water outlet equipment installed in a narrow space, including:
Step 1: opening a through hole on the bottom plate of the kitchen cabinet, providing the fitting into the hole, wherein the secure seat is completely embedded into the hole, and the locking receiver fits to the bottom plate of the kitchen cabinet;
Step 2: providing the water outlet equipment into the kitchen cabinet, and allowing the wheels to contact the bottom plate of the kitchen cabinet, and then slowly pushing the external case;
Step 3: pushing the external case until the mounting member of the base plate is fitted into the locking receiver of the kitchen cabinet to complete the installation.

Alternative, the present disclosure provides a method for assembling a water outlet equipment installed in a narrow space, including:
Step 1: anchoring the base plate and installing the mounting member to the bottom of the base plate;
Step 2: locking the water pump, the refrigeration system, and the compressor on the top of the base plate until the water pump and the compressor are on the same straight line to complete the first step installation of the water outlet equipment;
Step 3: locking the ice water tank above the water pump, installing the soda water tank in the ice water tank, connecting the refrigeration system to the ice water tank, and then securing the boiled water tank on the compressor until the ice water tank is level with the boiled water tank to complete the second step installation of the water outlet equipment;
Step 4: securing the front and rear shells of the base plate, and connecting the waterway and the circuit before assembling the external case to form the complete water outlet equipment.

The beneficial effects of the present disclosure are as follows.

In the present disclosure, by rationally arranging the positions of the water pump, the ice water tank, the compressor, and the boiled water tank, the large-sized water tanks are arranged side by side in the same row, and the small-sized water treatment components are arranged in the same row. Accordingly, the space occupation of each components is greatly reduced. The shape and structure of each components can be complementary, so that gaps therebetween is compact, and the circulation between waterways is not affected at all. This arrangement forms the water outlet equipment for narrow space, especially suitable for the narrow installation space under the single-bowl kitchen sink. With this, the market competitiveness of the products can be greatly improved.

In the present disclosure, through the pre-embedded fittings in the kitchen cabinet and the mounting members under the base plate, the water outlet equipment can first be slid into the cabinet through the wheels during installation, and then the water outlet equipment can be secured to the locking receiver. The match-up of the mount seat and the locking receiver will produce a sound so that users can be aware of the installation status without bowing. This reduces the difficulty of installing the water outlet equipment in the narrow space.

### BRIEF DESCRIPTION OF DRAWINGS

In order to illustrate the technical solutions of the embodiments of the present invention more clearly, the accompanying drawings used in the embodiments will be briefly introduced below. It should be understood that the following drawings only show some embodiments of the present invention, and therefore do not It should be regarded as a limitation on the scope, and those skilled in the art can also obtain other related drawings based on these drawings without creative work.

FIG. 1 is a schematic diagram of components under a single-bowl kitchen sink in the prior art.

FIG. 2 is a schematic diagram of the external appearance of a water outlet equipment installed in a narrow space according to embodiments of the present disclosure.

FIG. 3 is a schematic diagram of the external appearance of the water outlet equipment installed in a narrow space according to embodiments of the present disclosure.

FIG. 4 is a schematic diagram of the interior of the water outlet equipment installed in a narrow space provided according to embodiments of the present disclosure.

FIG. 5 is an alternative schematic diagram of the interior of the water outlet equipment installed in a narrow space according to embodiments of the present disclosure.

FIG. 6 is a top view of the interior of the water outlet equipment installed in a narrow space according to embodiments of the present disclosure.

FIG. 7 is a side view of the interior of the water outlet equipment installed in a narrow space according to embodiments of the present disclosure.

FIG. 8 is an exploded view of a fitting and a mounting member according to embodiments of the present disclosure.

FIG. 9 is a schematic side view of a waterway plate according to embodiments of the present disclosure.

FIG. 10 is a cross-sectional view at G-G in FIG. 9.

FIG. 11 is an alternative schematic diagram of the interior of the water outlet equipment installed in a narrow space, showing the filter member and carbon dioxide cylinder according to embodiments of the present disclosure.

FIG. 12 is a cross-sectional view of the ice water tank, showing the soda water tank inside the ice water tank according to embodiments of the present disclosure.

FIG. 13 is a schematic diagram of the interior of the water outlet equipment, showing the ice water tank, hot water tank in different shapes according to embodiments of the present disclosure.

FIG. 14 is a schematic diagram showing the hot water tank, the waterway plate, and the gas pump according to embodiments of the present disclosure.

FIG. 15 is a schematic diagram showing the hot water tank enclosed by a tank house, the waterway plat, and the gas pump according to embodiments of the present disclosure.

### DETAILED DESCRIPTION OF THE DISCLOSURE

For the implementation of the present invention, all belong to the protection scope of the present invention. Accordingly, the following detailed description of the embodiments of the invention provided in the accompanying drawings is not intended to limit the scope of the claimed invention, but merely represents selected embodiments of the invention. Based on the implementation manners in the present invention, all other implementation manners obtained by persons of ordinary skill in the art without creative efforts fall within the protection scope of the present invention.

In the description of the present invention, the terms “first” and “second” are only used for the purpose of description, and cannot be understood as referring to the purpose, technical solution and advantages of the method to be clearer. The following will be combined with the accompanying drawings in the embodiment of the present invention, clearly and completely describe the technical solutions in the embodiments of the present invention, obviously, the described embodiments are part of the embodiments of the present invention, but not all of them. Based on the embodiments in the present invention, all other embodiments obtained by persons of ordinary skill in the art without creative work show or imply relative importance or implicitly indicate the quantity of the indicated technical features. Thus, a feature defined as “first” and “second” may explicitly or implicitly include one or more of these features. In the description of the present invention, “plurality” means two or more, unless otherwise specifically defined.

In the modern apartment environment, its compact size determines the need to maximize the use of kitchen space. Existing kitchens often use a single-bowl sink, with a single cabinet structure at the bottom. On both sides of the water pipe, a garbage disposer may be placed, leaving only a small space for water outlets. However, as the functions of water outlets increase, the corresponding structures such as water tanks and water pipes also increase, and the overall size becomes larger, making it difficult to put the water outlets in the kitchen cabinet. Among them, it is difficult to use water outlets for home use in apartments. Large-scale water outlets can only be used for commercial use, occupy a small proportion of the market, and bring small profits to manufacturers. Therefore, in order to solve the above technical problems, this disclosure provides the following water outlet equipment.

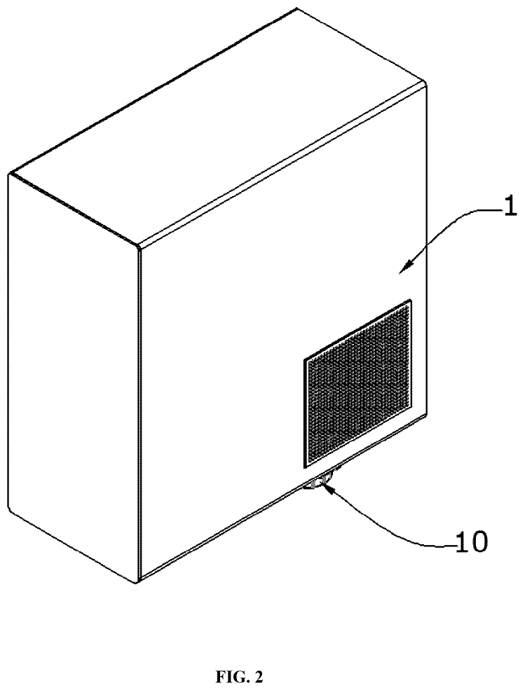

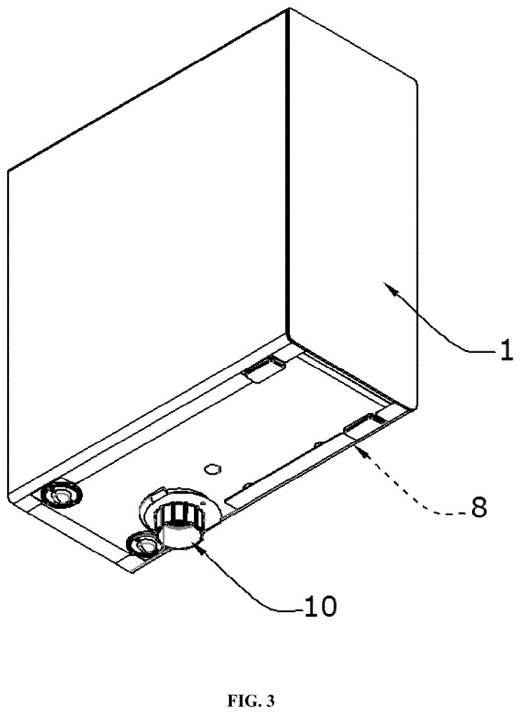

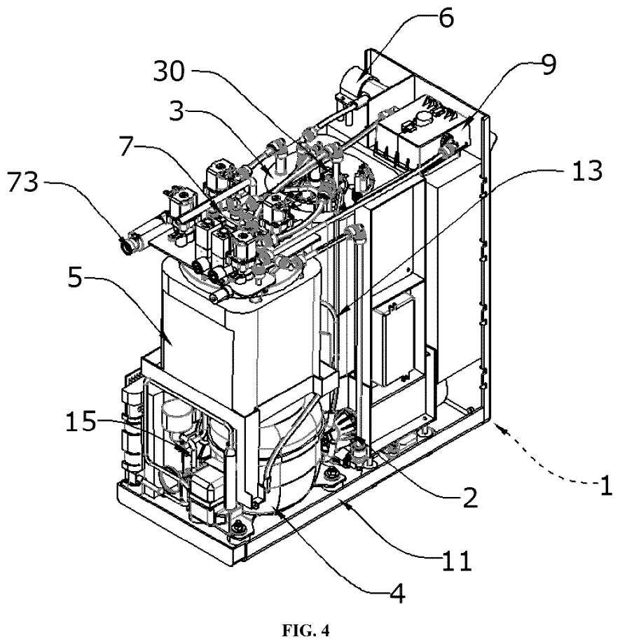

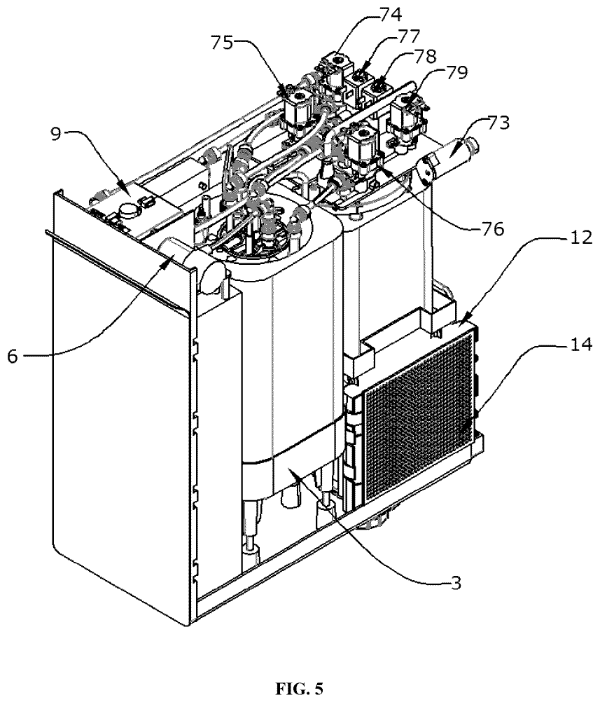

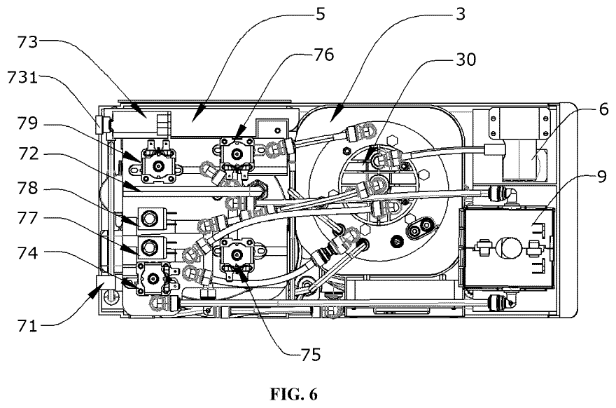

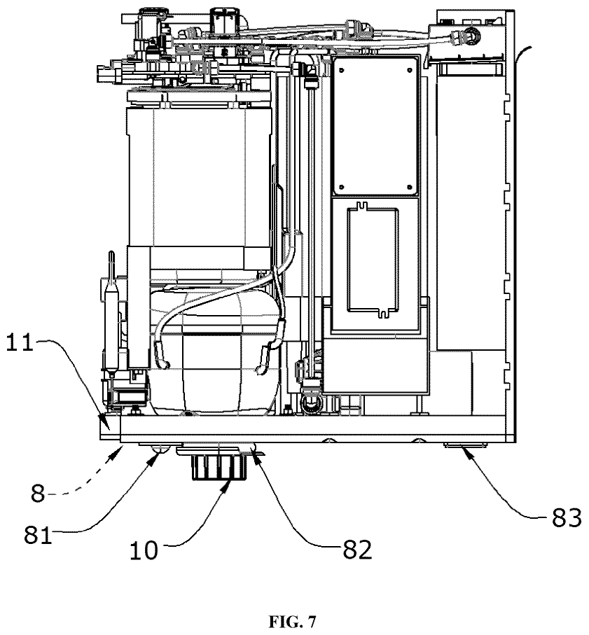

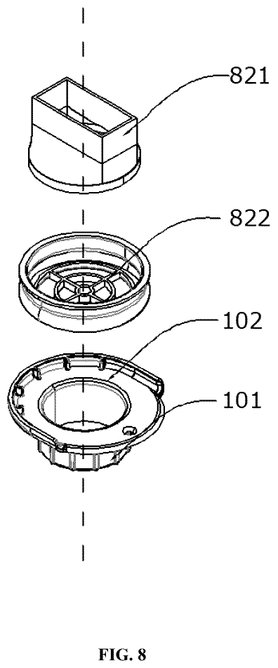

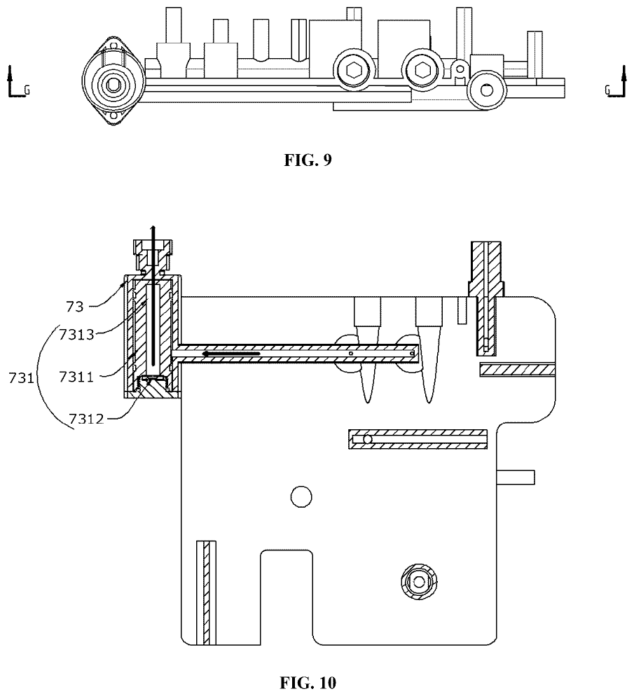

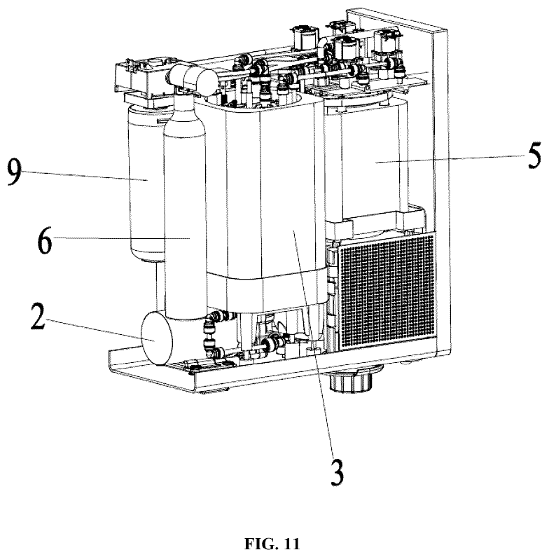

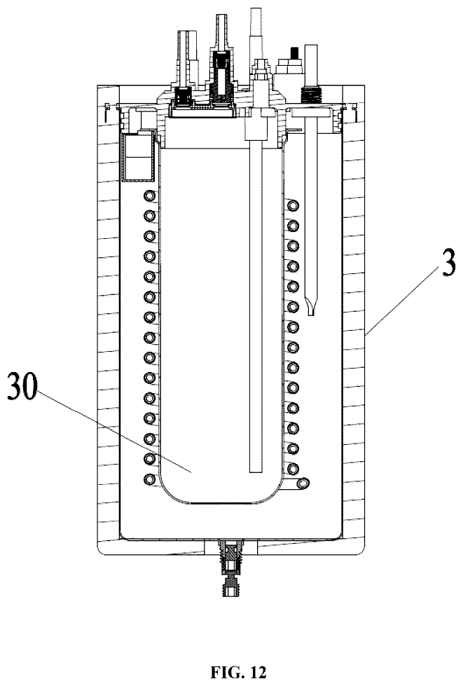

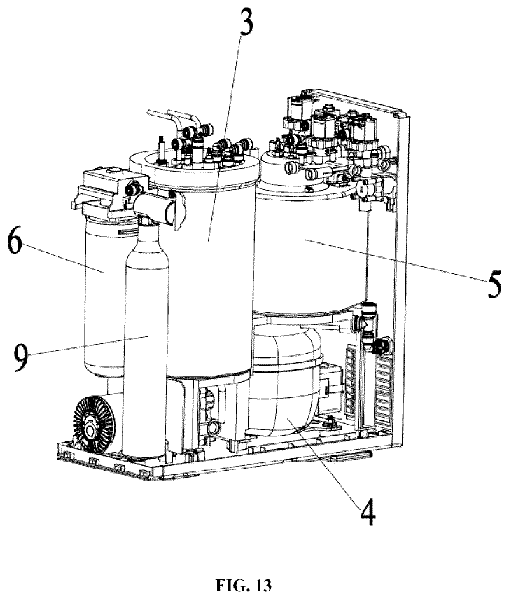

Referring to FIGS. 2-12, a water outlet equipment is illustrated. The water outlet equipment is installed with the single-bowl kitchen cabinet. The water outlet equipment includes an external case 1 having a base plate 11; water pump 2 sited on the base plate 11; an ice water tank 3 secured above the water pump 2, the ice water tank 3 being connected to a refrigeration system, and an interior of the ice water tank 3 is provided with a soda water tank 30; a compressor 4 sited on the same horizontal plane and the same straight line as the water pump 2; a boiled water tank 5 secured on the compressor 4, and is level with the ice water tank 3; a carbon dioxide cylinder 6 in fluid communication with the soda tank 30; a waterway plate 7 anchored on the a top of the boiled water tank 5, and the waterway plate 7 is in communication with the water pump 2, the boiled water tank 5, the compressor 4, the ice water tank 3, and the soda water tank 30, respectively; a fitting 10 disposed through the bottom of the kitchen cabinet, the fitting including a secure seat 101 attached to a bottom plate of the kitchen cabinet, and the secure seat 101 extending upward to provide a locking receiver 102; a mounting member 82 anchored under the base plate 11, the mounting member 8 including a plurality of wheels 81 slidably attached to the bottom of the kitchen cabinet, and a mount seat 82 adapted for the locking receiver 102. Further shown in FIG. 13, the ice water tank, the hot water tank may be in other shapes.

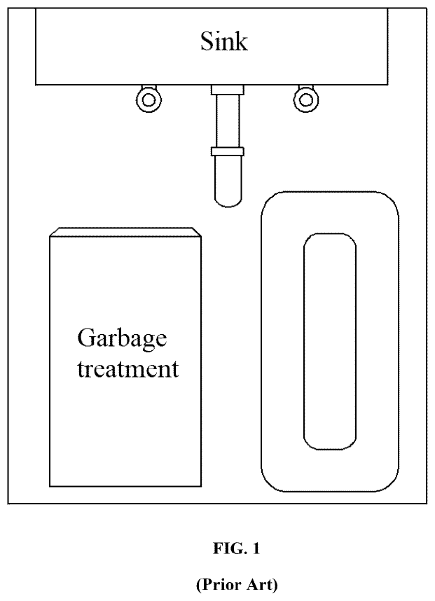

First of all, referring to FIG. 1, the space for the whole water outlet equipment is limited, and therefore it is pretty important to arrange the locations of each component. The large-sized components need to put together while same to the small-sized components, so that the space is occupied rationally. In view of this, the present disclosure first provides the small-scale soda water tank 30 into the ice water tank 3, and introduces different input and output pipe. Two tanks are boiled down to one and the occupation can be reduced. Then the ice water tank 3 and the boiled water tank are arranged in a line to form a narrow-shaped structure. At last, the rest components, including the water pump 2, the compressor 4 and etc., are arranged below the ice water tank 3 and the boiled water tank 5. Since the size of these components are smaller than that of the tanks, the width of the whole water outlet equipment is substantively equal to the width of the tanks. This greatly reduces the whole size of the water outlet equipment and allows the water outlet equipment to enter the narrow space within the kitchen cabinet.

However, it is obviously not the starting point of this disclosure to affect the use of the water outlet equipment with the size reduction of the water outlet equipment. Accordingly, in order to realize multiple functions of the water outlet, and allow each waterway to free of interference with each other and perform their duties. The waterway plate 7 is introduced in the present disclosure. All of the process, including water inlet, water separation, and water outlet, requires the distribution of the waterway plate 7. Under the distribution of the waterway plate 7, ice water, clean water, boiled water, soda water, and the like can be output by the water outlet equipment. Even though the size is reduced, multiple purpose of water output can be achieved anyway.

Before the introduction of the waterway, the pressure water may not be necessarily clean and sterile, the water outlet equipment installed in the narrow space further includes a filter member 9. The filter member 9 is connected to the waterway plate 7 through a pipe. Before the pressure water enters the waterway plate 7 for separation, all of the pressure water is forced to enter the filter member 9 for filtration. The pressure water becomes clean water after the filtration through the filter member 9. In this embodiment, the filter member 9 is a replaceable, and the material of the filter member includes activated carbon, ceramics, resin, etc.

After the pressure water is filtered into clean water by the filter member, it enters different tanks for treatments to generate water for different purposes. Therefore, a plurality of control valves with different functions are arranged in the waterway plate 7 for guiding the clean water to different tanks or water outlet positions. The specific arrangement is as follows: the waterway plate 7 includes a water inlet pipe 71 connected to the pressure water, a boiled water outlet pipe 72 connected to the boiled water tank 5, and a multi-purpose water outlet pipe 73 in communication with the ice water tank 3 and the soda water tank 30, a pressure water inlet solenoid valve 74 located between the water inlet pipe 71 and the filter member 9, a boiled water inlet solenoid valve 75 located between the filter member 9 and the boiled water tank 5, an ice water inlet solenoid valve 76 located between the filter member 9 and the ice water tank 3, soda water outlet solenoid valve 77 connected to the soda water tank 30, an ice water solenoid valve 78 connected to the ice water tank 3, and a clean water outlet solenoid valve 79 located between the multi-purpose water outlet pipe 73 and the filter member 9.

First of all, in the process of water intake, water needs to be introduced into the ice water tank 3 and the boiled water tank 5 respectively. Initially, opening the pressure water inlet solenoid valve 74 to allow the external pressure water to enter the filter member 9. The pressure water is filtered to be clean water by the filter member 9. Then opening the boiled water inlet solenoid valve 75 and the ice water inlet solenoid valve 76, respectively, to allow the clean water enters the boiled water tank 5 and the ice water tank 3 and becomes boiled water and ice water later. In this embodiment, an instant heater (not shown) is arranged within the boiled water tank, so that the clean water entering the boiled water tank can be boiled instantly. The ice water tank 3 is connected to the refrigeration system, and the refrigeration system is capable of cooling down the room temperature clean water to the ice water. More particularly, the refrigeration system includes a condenser 12 arranged on the base plate 11, a condensation pipe 13 connected to the condenser 12 and accessing to the ice water tank 3, a compressor 4 connected to the bottom of the boiled water tank 5. Alternatively, the refrigeration system further includes a evaporator (not shown). The refrigeration process through the condenser 12, the compressor 4, the evaporator, and the condensation pipe 13 is available in the prior art, and will not be repeated here.

After the ice water tank 3 and the boiled water tank 5 were all filled, the boiled water inlet solenoid valve 75 and the ice water inlet solenoid valve 76 were closed immediately. At this moment, the clean water still remains within the waterway plate 7. In this case, if the user needs clean water, he/she may open the clean water outlet solenoid valve 79 directly, and the clean water flows out from the multi-purpose water outlet pipe 73 directly by the clean water outlet solenoid valve 79.

When the ice water is expected, and the ice water has been formed within the ice water tank 3, the user may draw out the ice water from the ice water tank 3 directly. The water pumps 2 facilitates the drawn of the ice water from the ice water tank 3. At this moment, two water outlet status are existed. The first one is to open the ice water outlet solenoid valve 78 and output the ice water through the multi-purpose water outlet pipe 73, while the second one is to input the ice water into the soda water tank 30 through a pipe having a check valve. The arrangement of the check valve makes the pipeline only work for water inflow, and not water outflow.

When the boiled water is expected, and the boiled water has been formed within the boiled water tank 5, the user may open the boiled water inlet solenoid valve 75 directly, and the boiled water will be discharged from the boiled water outlet pipe 72 because of the continuously inflowing clean water. In this case, boiled water outlet solenoid valve is not required. Because the presence of a switch here will block the emission of hot steam generated during the water boiling, and even worse causing the expansion or explosion of the boiled water tank 5. Accordingly, the boiled water is discharged by the continuously inflow water pushing the boiled water, so that the hot water can be discharged safely in the water outlet equipment. It is to be noted that the pipeline is extended to the bottom of the boiled water tank 5 when the clean water is inflowing the boiled water tank 5, while the boiled water outlet pipe 72 is arranged on the top of the boiled water tank 5. By this arrangement, the bottom entering water can push the upper boiled water.

Soda water is a drink that contains 0.4-0.6 grams of sodium bicarbonate per liter, or directly pours carbon dioxide into drinking water and beverages to make it saturated. In this case, the carbon dioxide gas cylinder 6 are introduced. After the water enters the soda water tank 30, opening the channel between the carbon dioxide gas cylinder 6 and the soda water tank 30, the carbon dioxide is allowed to enter the soda water tank 30 and mix with water therein to form soda water. When the soda water is expected, opening the soda water outlet solenoid valve 77 directly, and the water within the soda water tank 30 will outflow from multi-purpose water outlet pipe 73.

Based on the above-mentioned water inlet and outlet steps, the compact arrangement of the ice water tank 3, the boiling water tank 5, the water pump 2, and the compressor 4 will not affect the use of clean water, ice water, boiled water, and soda water at all. By doing so, the water outlet equipment of the present disclosure is suitable for the single-bowl kitchen cabinet. Furthermore, the narrow-shaped structure in the present disclosure can also be applied in other large-scale or even industrial environments. The functions and use of the water out equipment is will not be sacrificed because of the reduced size.

In order to improve the quality of the water outlet and avoid the residual bacteria in the filtered water, a UV disinfection device 731 is used before the output of either one of ice water, clean water, or soda water. More specifically, the UV disinfection device 731 is embedded inside the multi-purpose outlet pipe 73. The UV disinfection device 731 includes an isolation shell 7311 connected to the multi-purpose water outlet pipe 73, a UV disinfection member 7312 arranged within the isolation shell 7311, an inner channel 7313 in communication with the waterway plate 7 and arranged within the isolation shell 7311. In this embodiment, the UV disinfection member 7312 may be an anti-virus lamp, a UV sterilizer, and the like, to carry out final safety treatment before the water other than boiled water is discharged. The antivirus principle of the UV disinfection member 7312 is available in the prior art, and will not be repeated here. Because the UV disinfection member 7312 emits ultraviolet rays, the long term use of the US disinfection member 7312 within the multi-purpose water outlet pipe 73 made of ordinary plastic will result in corrosion of the plastic pipe, and cause water safety problems. Therefore, the UV disinfection member 7312 is placed in the isolation shell 7311, and the water that needs to flow out of the multi-purpose water outlet pipe 73 will first enter the inner channel 7313 through the isolation shell 7311, pass through the UV disinfection member 7312 for disinfection, and then discharged from the multi-purpose water outlet pipe 73. This not only achieves the purpose of sterilization and disinfection, but also coexists stably with the pipeline. In this embodiment, the material of the isolation shell 7311 is Teflon, which is relatively corrosion-resistant.

After the problem of the water outlet is solved, the problem of installation needs to be surfaced. The existing installation method is that the user holds the water outlet equipment weighing several tens of kilograms in his arms, and puts it into the cabinet with his waist bowed. Because of the large weight, the water outlet equipment in the prior art cannot be pushed, and the user have to move it hardly, which is time-consuming and laborious. At the same time, it is difficult to ensure whether the water outlet equipment is installed in place and whether it needs to be re-adjusted later. Therefore, in the present disclosure, holes are provided in the kitchen cabinet, and fittings 10 are mounted in the holes. Furthermore, one end of the water outlet equipment of the present disclosure is provided with mounting member 8 for matching up the fittings 10, so that the water outlet equipment can be installed in place. Specifically, the fitting 10 is locked to the hole through a secure seat 101 for positioning the whole fitting 10. The locking receiver 102 is configured for locking. One end of the opening of the locking receiver 102 faces the opening of the kitchen cabinet. During the installation of the water outlet equipment, firstly, the whole water outlet equipment is pushed into the cabinet through the wheels 81, relieving lots of burden for the user to move the water outlet equipment. After a period of sliding, the mount seat 82 will snap into the locking receiver 102, and spread the opening of the locking receiver 102. The user will later hear a click sound, and that means the water outlet equipment is installed in place, and no more push is required. After the water outlet equipment is installed in place, the position of the water outlet equipment needs no more adjustment, and therefore saves labor for installation. With the use of wheels 81, the mount seat 82, and the locking receiver 102, the water outlet equipment can be slidden to expected positions and lock there. When disassembly is required, the user only needs to pull the water outlet equipment, so that the mount seat 82 is forced out from the locking receiver 102, and then slide the equipment. Convenience is created for both the installation and disassembling.

After the wheels 81 finish sliding, the mount seat 82 and the locking receiver 102 are secured, the bottom of the whole water outlet equipment is maintained a stable state, so the wheels are restricted. On the basis of the wheels 81 being arranged at the rear end, the sides of the bottom of the mounting part 8 away from the two wheels 81 are secured with a gasket 83. In the process of installation, tilting the water outlet equipment, firstly using the wheels 81 to slide the water outlet equipment to the designated position, and then leveling the water outlet equipment so that the gasket 83 is in contact with the bottom inside the kitchen cabinet. By doing so, the translocation phenomena such as slippage of the water outlet equipment after installation is avoided.

In addition, the mount seat 82 and the locking receiver 102 are not only a simple immobilization effect similar to a brake. In some water components capable of ice water production, due to the existence of components including the condenser 12, the condensation pipe 13, and the compressor 4, a large amount of heat will be output during the process of making ice water, which will increase the surrounding air temperature. If the hot air is not discharged in time, it may affect the normal operation of the equipment. In the prior art, an opening is provided on the cabinet for exhausting the hot air. However, in such prior art, the opening have to be located on the door of the cabinet, which has great damage both in terms of aesthetics and the integrity of the cabinet. In order to solve the this problem, in the present disclosure, first, an air intake net 14 is provided on one side of the external case 1, and an air intake fan 15 is arranged at a position corresponding to the air intake net 14, and the air intake fan 15 is arranged between the air intake net 14 and the condensers 12. The air intake fan 15 allows the external air to be introduced into the cabinet from side. Then, because the bottom of the air intake fan 15 is in communication with the mount seat 82, the secure seat 101 successively, the air intake from side surface will take away the heat generated by the refrigeration system. Moreover, the air intake for side may be exhausted to the outside of the kitchen cabinet through the mount seat 82, the secure seat 101 on the bottom. This side-intake and bottom-exhaust manner isolates the air intake and the air exhausting, so that the low-temperature intaking air is separated from the high-temperature exhausting air. This ensures the long term use of the machine without providing an opening on the door of the cabinet. The appearance and integrity of the whole equipment will not be affected, and makes the equipment more acceptable for people.

In order to receive air from the air intake fan 15 and form a better connection with the secure seat 101, the mount base 82 includes an air collecting hopper 821 connected to the air intake fan 15, and a mounting ring 822 secured on the external of the bottom of the air collecting hopper 821. The mounting ring 822 is hollow, and an outer diameter of the mounting ring 822 is fitted to inner diameter of the locking receiver 102. The top of the air collecting hopper 821 is a rectangular-shaped structure connected to the air intake fan 15, and the bottom of the air collecting hopper 821 is an inverted bowl-shaped structure. The bowl edge of the inverted bowl-shaped structure is fitted with the mounting ring 822. The bowl-shaped structure may increase the air passing volume. Moreover, because the mounting ring 822 needs an air passing space, and cannot be completely hollow, a plurality of ribs are arranged whin the mounting ring 822 to form a cutout arrangement. This increases the strength of the mounting ring without affecting the air passing.

Further to the above description, the air intake fan 15 is arranged between the intake net 14 and the condenser 12. The surface temperature of the condenser 12 is cold, so that the air introduced by the air intake fan 15 will be cooled when passing through the condenser 12. This helps to bring more heat in the hot environment of the bottom of the water outlet equipment.

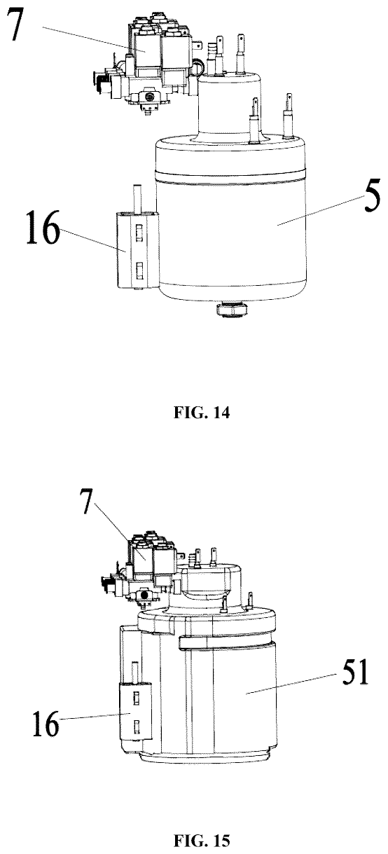

As show in FIG. 14 and FIG. 15, the present embodiment further comprises a gas pump 16 located adjacent to the hot water tank 5. Optionally, the hot water tank 5 is enclosed by a tank house 51, and the gas pump 16 is attached to the tank house 51. The gas pump is in fluid communication with the waterway plate 7, especially the multi-purpose water outlet pipe 73. This arrangement allows to keep the multi-purpose water outlet pipe 73 dry. The gas pump 16 is capable of pumping gas through the waterway plate, especially the multi-purpose water outlet pipe 73. The flowing gas will take away the residual water in the multi-purpose water outlet pipe 73, and thus keep the multi-purpose water outlet pipe 73 dry after use. Accordingly, the water pathway and water pipes of the present disclosure can remain dry after the ice water or soda water is released. This effectively inhibits bacterial growth and exhibits antibacterial properties in the water pathway and water pipes.

In alternative embodiment, the present disclosure further provides a method for installing the water outlet equipment in a narrow space. The method including the following steps.

Step 1: opening a through hole on the bottom plate of the kitchen cabinet, providing the fitting 10 into the hole, wherein the secure seat 101 is completely embedded into the hole, and the locking receiver 102 fits to the bottom plate of the kitchen cabinet.

Step 2: providing the water outlet equipment into the kitchen cabinet, and allowing the wheels 81 to contact the bottom plate of the kitchen cabinet, and then slowly pushing the external case 1.

Step 3: pushing the external case 1 until the mounting member 8 of the base plate 11 is fitted into the locking receiver 102 of the kitchen cabinet to complete the installation.

The installation method as provided firstly allows the user to slide the water outlet equipment easily. After the water outlet equipment is shied to the expected position, it allows the user to be aware of the installation status of the water outlet equipment. The opening on the bottom of the equipment is not only for air exhausting, but also for presetting the fitting 10. One hole for two purposes. By the opening, both air exhausting and positioning installation are achieved.

The opening on the bottom of the kitchen cabinet avoids the front surface of the kitchen cabinet to be pierced. The opening on the bottom will not affect the appearance of the whole equipment, and therefore improving the aesthetic appearance and integrity of the kitchen cabinet.

The fitting preset on the bottom of the kitchen cabinet allows the water outlet equipment can be guided, and fitting into the proper position correctly and stably. Furthermore, once the equipment is secured, it exhibits a great stability and will not be easy to slide it again.

Because the water outlet equipment is installed in the single-bowl kitchen cabinet with limited installation space, the size of the water outlet equipment is a matter of great account. The size of water outlet equipment in the prior art definitely cannot be installed into the kitchen cabinet with limited space. Accordingly, the equipment must be assembled in layers, and the structures of each layer are in a side-by-side state, so as to form the water outlet equipment that can be installed in a narrow space.

Accordingly, another embodiment of the present disclosure provides a method for assembling the water outlet equipment adapted narrow space. The method includes the following steps.

Step 1: anchoring the base plate 11 and installing the mounting member 8 to the bottom of the base plate 11;

Step 2: locking the water pump 2, the refrigeration system, and the compressor 4 on the top of the base plate 11 until the water pump 2 and the compressor 4 are on the same straight line to complete the first step assembly of the water outlet equipment;

Step 3: locking the ice water tank 3 above the water pump 2, installing the soda water tank 30 in the ice water tank 3, connecting the refrigeration system to the ice water tank 3, and then securing the boiled water tank 5 on the compressor 4 until the ice water tank 3 is level with the boiled water tank 5 to complete the second step assembly of the water outlet equipment;

Step 4: securing the front and rear shells of the base plate 11, and connecting the waterway and the circuit before assembling the external case 1 to form the complete water outlet equipment.

First, mounting the base plate first, and then placing water treatments such as the water pump 2, the refrigeration system, and the compressor 4 at the bottom, and placing the water tank on the top. It should be noted that the water treatments are arranged side by side, and the water tanks are also arranged side by side. From the front view, the entire water outlet equipment only occupies the length of one water tank, and the overall space is compressed to the narrowest.

The above descriptions are only preferred embodiments of the present invention, and are not intended to limit the present invention. For those skilled in the art, the present invention may have various modifications and changes. Any modifications, equivalent replacements, improvements, etc. made within the spirit and principles of the present invention shall be included within the protection scope of the present invention.

What is claimed is:

1. A water outlet equipment adapted for a narrow space, wherein the water outlet equipment is installed within a single-bowl kitchen cabinet; the water outlet equipment comprises:
an external case having a base plate;
a water pump sited on the base plate;
an ice water tank secured above the water pump, the ice water tank being connected to a refrigeration system, and an interior of the ice water tank is provided with a soda water tank;
a compressor sited on the same horizontal plane and the same straight line as the water pump;
a boiled water tank secured on the compressor, and is level with the ice water tank;
a carbon dioxide cylinder in communication with the soda tank;
a waterway plate anchored on the a top of the boiled water tank, and the waterway plate is in communication with the water pump, the boiled water tank, the compressor, the ice water tank, and the soda water tank, respectively;
a fitting disposed through the bottom of the kitchen cabinet, the fitting comprising a secure seat attached to the base plate of the kitchen cabinet, and the secure seat extending upward to provide a locking receiver;
a mounting member anchored under the base plate, the mounting member comprising a plurality of wheels slidably attached to the bottom of the kitchen cabinet, and a mount seat adapted for the locking receiver.

2. The water outlet equipment according to claim 1, wherein the water outlet equipment further comprises a filter member; the filter member is connected to the waterway plate through a pipe; the waterway plate comprises a water inlet pipe connected to a pressured water, a boiled water outlet pipe in fluid communication with the boiled water tank, a multi-purpose water outlet pipe in fluid communication with the ice water tank and the soda water tank, a pressure water inlet solenoid valve located between the water inlet pipe and the filter member, a boiled water inlet solenoid valve located between the filter member and the boiled water tank, an ice water inlet solenoid valve located between the filter member and the ice water tank, a soda water outlet solenoid valve connected to the soda water tank, an ice water outlet solenoid valve connected to the ice water tank, and a clean water outlet solenoid valve located between the multi-purpose water outlet pipe and the filter member.

3. The water outlet equipment according to claim 1, wherein the refrigeration system comprises a condenser arranged on the base plate, a condensation pipe connected to the condenser and access to the ice water tank, and a compressor connected to a bottom of the boiled water tank.

4. The water outlet equipment according to claim 1, wherein an air intake net is arranged on one side of the external case, an intake fan is located at a position corresponding to the air intake net, and the intake fan is arranged between the air intake net and the condenser.

5. The water outlet equipment according to claim 1, wherein the bottom of the air intake fan is in communication with the mount seat and the secure seat in sequence.

6. The water outlet equipment according to claim 1, wherein the mount seat comprises an air collecting hopper connected to the air intake fan, and a mounting ring secured on the external of the bottom of the air collecting hopper; the mounting ring is hollow, and an outer diameter of the mounting ring is fitted to inner diameter of the locking receiver.

7. The water outlet equipment according to claim 1, wherein a UV disinfection device is embedded inside the multi-purpose water outlet pipe; the UV disinfection device comprises an isolation shell connected to the multi-purpose water outlet pipe, a UV disinfection component arranged within the isolation shell, and an inner channel in communication with the waterway plate and located within the isolation shell.

8. The water outlet equipment according to claim 6, wherein a gasket is secured to one side of the bottom of the mounting member away from the wheel.

9. A method for installing the water outlet equipment adapted for a narrow space according to claim 1, comprising the following steps:
Step 1: opening a through hole on the bottom plate of the kitchen cabinet, providing the fitting into the hole, wherein the secure seat is completely embedded into the hole, and the locking receiver fits to the bottom plate of the kitchen cabinet;
Step 2: providing the water outlet equipment into the kitchen cabinet, and allowing the wheels to contact the bottom plate of the kitchen cabinet, and then slowly pushing the external case; and
Step 3: pushing the external case until the mounting member of the base plate is fitted into the locking receiver of the kitchen cabinet to complete the installation.

10. A method for assembling the water outlet equipment adapted for a narrows space according to claim 1, comprising the following steps:
Step 1: anchoring the base plate and assembling the mounting member to the bottom of the base plate;
Step 2: locking the water pump, the refrigeration system, and the compressor on the top of the base plate until the water pump and the compressor are on the same straight line to complete the first step assembly of the water outlet equipment;
Step 3: locking the ice water tank above the water pump, mounting the soda water tank in the ice water tank, connecting the refrigeration system to the ice water tank, and then securing the boiled water tank on the compressor until the ice water tank is level with the boiled water tank to complete the second step assembly of the water outlet equipment; and
Step 4: securing the front and rear shells of the base plate, and connecting the waterway and the circuit before assembling the external case to form the complete water outlet equipment.
